(19) United States
(12) Patent Application Publication
(10) Pub. No.: US 2007/0008084 A1
(43) Pub. Date: Jan. 11, 2007

(54) Electronic license plate system changing displayed information and method for the same

(76) Inventors: Sen-Jia Wu, Taipei City (TW); Hao-Lan Tang, Taipei City (TW); Yu-Tsung Hsu, Taipei City (TW); Yu-Tang Huang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/172,791

(22) Filed: Jul. 5, 2005

(51) Int. Cl. G05B 19/00; B60Q 1/00

(52) U.S. Cl. 340/425.5; 340/5.61

(57) ABSTRACT

An electronic license plate system capable of changing information displayed thereon and method for the same is a display device installed on in a motor vehicle showing information according to random instructions given by a traffic control system, serving as an illuminated license plate for easy visual identification. The displayed contents of the license plate varies with time and location to prevent counterfeiting or a shut-down event, and alertness and road security may be raised in areas with poor visibility due to the illuminated license plate. The electronic license plate working with the traffic control system may reach the functions of unmanned charge, dynamic geographic information, unmanned traffic control, road use information, and traffic statistics, and may provide a functional intelligent traffic system (ITS) for prevention of license plate counterfeiting and vehicle theft.

### BACKGROUND OF THE INVENTION

1. Field of the Invention

This present invention relates to an electronic license plate system, and particularly to an electronic license plate system that changes displayed information and a method of delivering, receiving, updating and displaying the information of the system.

2. Description of Related Art

With the advance of science and technology and adding the development of communication and network technology, conventional vehicles were formerly equipped with outfits and systems for speedy and easy driving, and now are equipped with multimedia, network, GPS, and communication systems, as well as security systems.

However, conventional license plates used for identification have not been improved. By means of simple technology, the number of a license plate may be falsified so that stolen vehicles can run on roads and not easily be found, causing big problems in public security. Further, under the conditions of poor visibility, dense fog, poor light, or no street lamp illumination at night, if a driver forgets or does not turn on headlights and suddenly drives into a tunnel, when a traffic accident happens in front or a state of emergency occurs in the vehicle or inside the vehicle, the conventional license plate cannot provide information to inform the car driver or other car drivers nearby of the change to allow them to better cope with the various states of emergency.

### SUMMARY OF THE INVENTION

An electronic license plate system capable of changing information displayed thereon comprises at least a wireless communication device, a display device, a database, and a processing device. The wireless communication device is electrically connected to the processing device for signal reception and transmission. The processing device is electrically connected to the display device and the database in order to access the database according to a request signal, and uses the wireless communication device to transmit information in the database or display the same on the display device. The database stores at least one piece of identification information, an identification code, and a piece of information under a set condition or equivalent. The system further comprises a power supply to provide an uninterruptible power supply to the system.

An operation method of the electronic license plate that can change information displayed thereon comprises receiving a signal corresponding to the system and determining whether the signal updates the piece of identification information. If the signal updates the identification information, it updates the identification information in the database of the electronic license plate system and the information is displayed. A step of determining whether the signal updates the identification information comprises determining whether the signal is the updating setting if the signal does not update the identification information. At the step of determining whether the signal updates setting, if the signal updates the setting, it updates a setup state of the electronic license plate system and the identification information is displayed. The step of displaying the identification information further comprises transmitting the signal of the identification information.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of an electronic license plate system capable of changing information displayed thereon according to the present invention;

FIG. 2 is a flow chart of the method of operating the electronic license plate system capable of changing information displayed thereon according to the present invention; and

FIG. 3 is a schematic view illustrating the method of operating the electronic license plate system capable of changing information displayed thereon according to the present invention.

### DETAILED DESCRIPTION OF THE PREFERRED EMBODIMENTS

In order to further understand the technical means and effects adopted to achieve the objectives of this invention, refer should be made to the detailed description and accompanied drawings according to this invention. It is believed that the objectives, features, and points of this invention will be apparent from the description; however, the accompanied drawings are provided for reference and illustration only and not intended to limit the terms or scope of this invention.

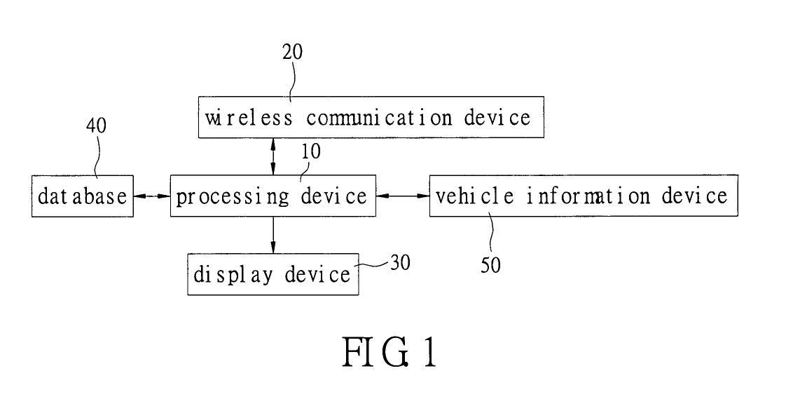

FIG. 1 is a schematic view illustrating an electronic license plate system capable of changing information displayed thereon according to the present invention. The electronic license plate system includes at least one wireless communication device 20, a display device 30, a database 40, and a processing device 10. The wireless communication device 20 is electrically connected to the processing device 10 for signal receiving and transmission. The processing device 10 is electrically connected to the display device 30 and the database 40 in order to access the database 40 according to a first request signal and uses the wireless communication device 20 to transmit information in the database 40 or displays the same on the display device 30. The first signal updates information in the database, setting, or other pieces of information. The database 40 stores at least one piece of identification information, an identification code, and a piece of information under a set condition or other pieces of information. The display device 30 is, for example, an LED, an OLED, an LCD, or an equivalent thereof. The system further comprises a power supply (not shown), in which the power supply is independent or dependent on the vehicle, and is charged by solar power or other media to keep the system uninterruptible and normally working whenever the vehicle runs or is stationary. The wireless communication device 20 is a communication module for an integrated wireless LAN, a GPS, and a GPRS, and further comprises a 2.4 GHz antenna, a 5.8 GHz antenna, and an antenna of wireless RFID chip embedded with the GPS.

The electronic license plate system capable of changing information displayed thereon further comprises a vehicle information device 50. The vehicle information device 50 is electrically connected to the processing device 10. The vehicle information device 50 is used to transmit a second signal to the processing device 10. The processing device 10 stores the second signal in the database 40 upon its request and transmits the second signal or information in the database through the wireless communication device 20 or has either of the two displayed on the display device 30. The processing device 10 also receives the first signal or the information in database from the wireless communication device 20 and transmits either of the two to the vehicle information device 50. The second signal is a vehicle state, a piece of road situation information, a piece of charge information, a piece of guard information, a piece of vehicle-inside information, a piece of emergency information, other pieces of information, or combinations thereof. The vehicle information device 50 is a vehicle information processor (VIP) device.

The electronic license plate system capable of changing information displayed thereon and a method for the same are used to determine, according to displayed identification information for the vehicle at a specified range in a region, whether the vehicle is allowed to enter the specified region. A traffic control system is used to directly transmit a piece of identification information to a specified electronic license plate system or through a base station. After receiving the information, the system further determines whether the information is updated identification information, and if it is updated, the database of the electronic license plate system is updated and the latest identification information is transmitted to the display device and then displayed on the device so that an administrator in the specified region may determine whether the vehicle provided with the electronic license plate system is allowed to enter the specified region. Besides, the electronic license plate system may also transmit the received identification information out of the wireless communication device of the electronic license plate system and determine the information to be the latest identification information through a monitoring system at the specified region, or the base station at the specified region detects the information of electronic license plate system as the latest identification information, and the administrator determines the vehicle is allowed to enter the specified region.

Taking city traffic as an example, a vehicle with only a license plate number or a last odd number of an identification code may enter the city center and run on freeway or other specified regions for achievement of controlling the number of vehicles and keeping the traffic smooth. The traffic control system at a specified time directly transmits a piece of updated information for all on-line electronic license plate systems or through the base station, or detects qualified electronic license plate system for transmission of update information. When the system receives the update information, it updates the database and next shows or transmits the information. When the vehicle enters the city center or the specified region, the administrator or policeman determines whether the vehicle is allowed to enter or uses a stationary or mobile monitoring system to determine whether the vehicle is allowed to enter. The traffic control system may also casually change the identification information as an anti-counterfeiting measure, and update the set condition of electronic license plate system to transmit other signals of information and, for example, alter to transmit an identification code, a piece of real-time information, or the equivalent.

Moreover, vehicles in all regions may also use the electronic license plate system. For example, the traffic control system updates the identification information for the vehicles provided with an on-line electronic license plate system through the base station and irregularly updates the identification information so that vehicles not provided with the electronic license plate system, stolen but reported to the police, or being investigated while running on roads, are easily found because the vehicles cannot receive the update identification information. The electronic license plate system thus also provides protection guarding against theft and aids in finding criminals.

Further, in, for example, parts of regions, the traffic control system can transmit a piece of real-time information for parts of regions where a dangerous event has happened or will easily happen through the base station or an on-line transmission system. For example, when the traffic control system is informed of dense fog happening in a region that causes drivers to have poor visibility affecting the driver's driving security, the traffic control system immediately transmits updated settings or real-time information to vehicles provided with online electronic license plate system in the region. When the electronic license plate receives the signal, it changes the set condition and transmits the real-time information to the display device to be displayed so that the display device of the electronic license plate system is set for transmitting stronger rays of light, glittering light, characters, graphics, or other warnings in order to give the warnings to car drivers nearby to keep a distance between the moving vehicles. In another example, when entering a tunnel, a mountain, or a dangerous region, the vehicles provided with the electronic license plate system may also be informed of a warning by the method described above.

Further, the electronic license plate system may also be connected to a vehicle information device, and if the car driver is in a state of emergency, the driver uses an operation device in the car to have the emergency information displayed through the electronic license plate system or transmit the information to the traffic control system for notification or report to the police. When the vehicle is started, the electronic license plate system shows its function and condition in the vehicle through the vehicle information device to inform the car driver of the same, so when the electronic license plate system is abnormal, the driver may repair it as soon as possible.

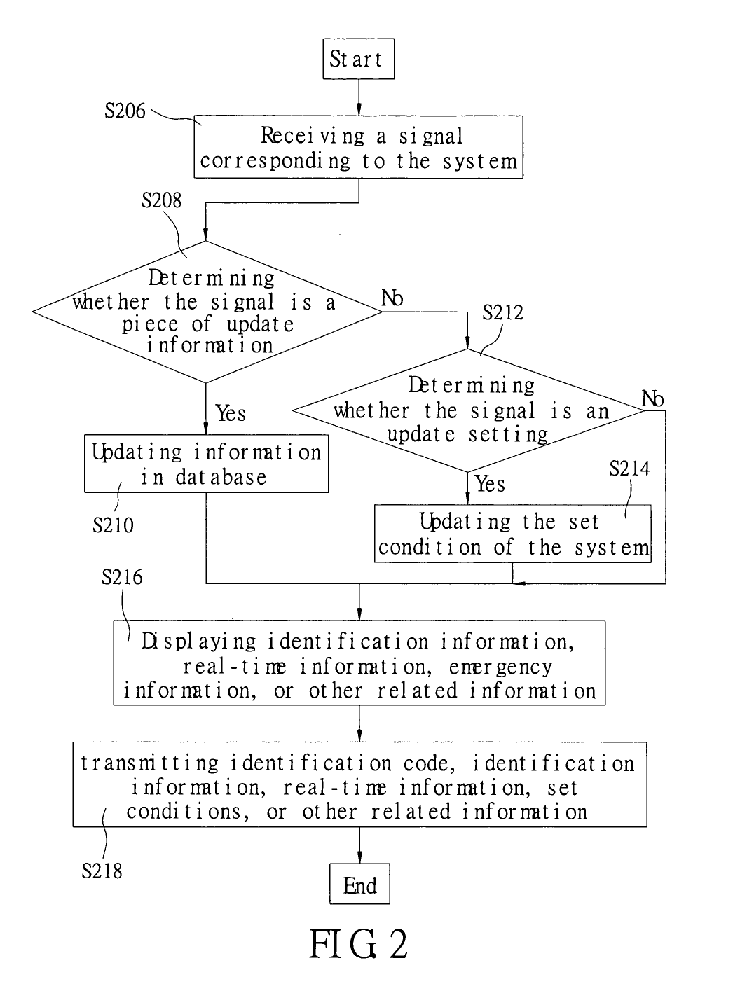

FIG. 2 is a flow chart of the method of operating the electronic license plate system capable of changing information displayed thereon according to the present invention. When connecting with the traffic control system, the electronic license plate system starts to work, in which the working method comprises receiving a signal (S206) corresponding to the system and determining whether the signal updates the piece of identification information (S208). If the signal updates the identification information, it updates the identification information (S210) in the database 40 of the electronic license plate system and the identification information (S216) is displayed on the display device 30. A step (S208) of determining whether the signal updates the identification information comprises determining whether the signal is that (S212) updating setting if the signal does not update the identification information. In step (S212), whether the signal updates the setting is determined. If the signal updates the setting, it updates a setup state (S214) of the electronic license plate system and displays the identification information (S216). Step (S216) of displaying the identification information further comprises transmitting the signal (S218) of identification information. Step (S218) of transmitting the signal of identification information is further comprises transmitting an identification code, a piece of real-time information, a piece of emergency information, a set condition, or other signals of information. Step (S216) of displaying identification information further comprises displaying a piece of real-time information, an emergency information, or other pieces of information. The identification information is characters, figures, images, or a combination of the same.

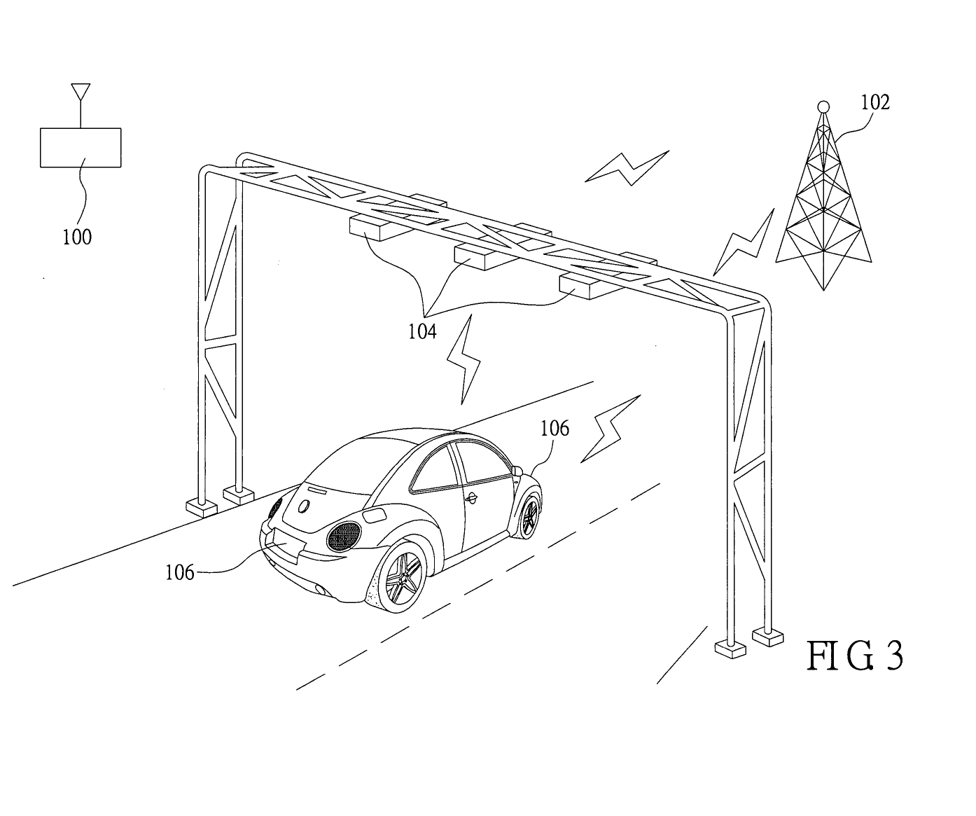

FIG. 3 is a schematic view illustrating the method of operating the electronic license plate system capable of changing information displayed thereon according to the present invention, in which the system comprises the traffic control system 100, the base station 102, the monitoring device 104, and the electronic license plate display device 106. The central control system transmits to the base station 102 a signal containing information to be displayed on the electronic license plate display device 106, update information, or update settings. The base station transmits the signal directly or through the monitoring device 104 to the electronic license plate system of the vehicle. After receiving the signal, the electronic license plate system operates according to the signal, and, for example, the information is displayed through the electronic license plate display device 106 or directly transmitted to the base station or to the traffic control system 100 for determination and processing, or the electronic license plate system transmits the information of request back to the monitoring device 104 and back to the traffic control system 100 directly or through the base station 102 for determination and processing.

To sum up, the method of operating the electronic license plate system capable of changing information displayed thereon according to the present invention has the following advantages:
1. Information display and transmission is used to easily identify the vehicles using the system.
2. In a special region or at a state of emergency, information display and transmission may also be used for achievement of notification.
3. A vehicle information device is connected to show or transmit requests or all states of the vehicle or driver through the system, and the information and state received by the electronic license plate system may also be transmitted back to the vehicle information device to inform the car driver of the same.

For the method of receiving and transmitting signals according to this invention, various means of communication are used. This invention may also be connected to various vehicle-use information processing device, and the display device according to this invention also uses various proper display devices meeting the purposes above for achievement of the functions described above.

However, in the description mentioned above, only the preferred embodiments according to this invention are provided without limit to this invention and the characteristics of this invention; all those skilled in the art without exception should include the equivalent changes and modifications as falling within the true scope and spirit of the present invention.

What is claimed is:

1. A method of operating an electronic license plate system capable of changing information displayed thereon, working with a traffic control system, the method comprising:
receiving a wireless signal transmitted from the traffic control system;
determining whether the wireless signal is identification information; and
displaying the identification information if the wireless signal is identification information.

2. The method of claim 1, wherein the step of receiving the wireless signal transmitted from the traffic control system further comprises receiving a signal from a vehicle information device.

3. The method of claim 1, wherein the step of determining whether the wireless signal is identification information is determined through a processing device, further comprising:
determining whether the wireless signal is information for updating a database of the electronic license plate system, and updating the database if the wireless signal is information for updating the database of the electronic license plate system.

4. The method of claim 3, wherein the step of determining whether the wireless signal is the step of updating the identification information, further comprising:
determining whether the signal is that an updating setting if the wireless signal is not information for updating the database.

5. The method of claim 4, wherein whether the wireless signal is a signal updating setting is determined, and if the wireless signal is the signal updating setting, a set condition of the electronic license plate system is updated.

6. The method of claim 1, wherein the step of displaying identification information is accomplished with a display device.

7. The method of claim 1, wherein the step of updating the information of database comprises updating an identification code, a piece of request information, a piece of vehicle information, a piece of vehicle-inside information, a piece of real-time information, a piece of emergency information, or a set condition.

8. The method of claim 7, wherein the identification code is a license plate number of the system, an engine number, a serial number of the vehicle using the electronic license plate system, or a combination thereof.

9. The method of claim 1, wherein the step of displaying identification information further comprises transmitting a signal of identification information, and the step of transmitting the signal of identification information and receiving a signal corresponding to the electronic license plate system is implemented through a wireless communication device.

10. The method of claim 1, wherein the step of displaying the identification information further comprises displaying a piece of real-time information, a piece of vehicle-inside information, a piece of emergency information, or any piece of information in the database.

11. The method of claim 9, wherein the step of transmitting the identification information further comprises transmitting a piece of real-time information, a piece of vehicle-inside information, a piece of emergency information, or any piece of information in the database.

12. The method of claim 1, wherein the identification information is characters, figures, images, or a combination thereof.

13. An electronic license plate system capable of changing information displayed thereon, working with a traffic control system, the electronic license plate system comprising:
at least a wireless communication device;
a display device;
a database; and
a processing device, electrically connected to the wireless communication device, the display device, and the database, wherein the processing device uses the wireless communication device to transmit and receive signals to and from the traffic control system, accesses the database according to the requests of the received signals, and transmits information in the database through the wireless communication device or displays the information through the display device.

14. The electronic license plate system of claim 13, wherein the signal is a piece of information updating the database or an update setting.

15. The electronic license plate system of claim 14, wherein the system updates a set condition according to the signal updating setting.

16. The electronic license plate system of claim 13, wherein the database stores at least a piece of identification information, an identification code, or a piece of information under a set condition.

17. The electronic license plate system of claim 13, wherein the display device is an LED, an OLED, or an LCD.

18. The electronic license plate system of claim 13, further comprising a power supply to provide an uninterruptible power supply thereto.

19. The electronic license plate system of claim 13, wherein the wireless communication device is a communication module for an integrated wireless LAN, a GPS, and a GPRS.

20. The electronic license plate system of claim 13, wherein the wireless communication device comprises a 2.4 GHz antenna, a 5.8 GHz antenna, and an antenna of wireless RFID chip embedded with the GPS.

21. The electronic license plate system of claim 13, further comprising:
a vehicle information device, electrically connected to the processing device, transmitting the vehicle-inside information or a piece of information to the processing device storing the information in the database upon request, or transmitting information or information in a database through the wireless communication device, or displaying information or information in the database through the display device, and also transmitting the signal received by the wireless communication device or information in the database to the vehicle information device.

22. The electronic license plate system of claim 16, wherein the database further stores at least a piece of vehicle information or at least a piece of vehicle-inside information.

23. The electronic license plate system of claim 22, wherein the vehicle information is a vehicle state, a piece of information of situation on road, a charge information, a notice for guarding against theft, a piece of vehicle-inside information, an emergency notice, or a combination thereof.
